(19) United States
(12) Patent Application Publication
(10) Pub. No.: US 2018/0350163 A1
(43) Pub. Date: Dec. 6, 2018

(54) Method of Externally Assessing Damage to a Vehicle

(71) Applicant: Claim Genius Inc., Iselin, NJ (US)

(72) Inventors: Raj Pofale, Iselin, NJ (US); Hemant Joshi, Scotch Plains, NJ (US)

(21) Appl. No.: 16/001,932

(22) Filed: Jun. 6, 2018

Related U.S. Application Data
(60) Provisional application No. 62/515,829, filed on Jun. 6, 2017.

(51) Int. Cl. G07C 5/00; G06T 7/00; G07C 5/08; G06Q 40/08; G06Q 30/02

(52) U.S. Cl. CPC G07C 5/008; G06T 7/001; G07C 5/0808; G07C 5/0816; G06N 99/005; G06Q 40/08; G06Q 30/0283; G06T 2207/30268; G06T 2207/30252; G07C 5/085

(57) ABSTRACT

Disclosed is a system and a method of externally assessing damage to a vehicle.

The current application claims a priority to the U.S. Provisional Patent application Ser. No. 62/515,829 filed on Jun. 6, 2017.

### FIELD OF THE INVENTION

The present invention relates generally to determining salvage value of vehicles. More specifically, the present invention is a predictive damage analysis and vehicle pricing method. More specifically, the present invention is a predictive image analysis to determine the severity of the damage and estimating the price.

### BACKGROUND OF THE INVENTION

Salvaged vehicles get auctioned for various reasons. A car being salvaged is still valuable; for example, the vehicles may be recycled for parts or the damaged parts may be replaced. The history of purchase and bid price of salvaged vehicle is typically determined by year, make and model of the vehicle and average price a particular location sells that vehicle for.

Accordingly, there are systems available to salvage value of a damaged vehicle based on past sales. Further, some systems predict repair value to determine salvage value. However, the information about the vehicle indicating the damage to the vehicle is provided manually to such systems. This leads to a lot of investment in terms of time and money.

Therefore, there is a need for a system and a method for determining a value of a damaged vehicle with less manual effort.

### SUMMARY OF THE INVENTION

Disclosed is a system and method for determining a value of a damaged vehicle.

In some embodiments, the system may employ multiple algorithms to determining a value of a damaged vehicle.

In some embodiments, the system may maintain a database of past sales. The database may include information about one or more of vehicle type, vehicle year, vehicle make, vehicle model, vehicle series, mileage, engine type, original sale date, original sale price, repair estimate, air bags deployed, customer type, title type, and missing parts.

In some embodiments, a user may provide information about a damaged car to the system.

In further embodiments, the system may analyze the information provided by a user to rate the damaged car against various parameters. Thereafter, the ratings against various parameters may be collated to obtain a value of the damaged vehicle.

In further embodiments, the system may also provide one or more of repair cost, parts cost, resell value and profit.

In some embodiments, a method for predicting price of a damaged vehicle is disclosed. The method takes into account, type of damage, make, model, year, frame type, trim, engine, mileage and history of typical pricing.

In further embodiments, a machine learning model is used with damaged vehicle image analysis using deep learning approach.

In some embodiments, a specific type of custom designed Neural Networks called Convolutional Neural Networks (CNNs) is used for image analysis of damaged vehicles. The CNN analysis may be combined with results with other vehicle related information to predict price accurately. Neural Networks are useful in various tasks such as autonomous vehicle driving, image analysis, music recommendations, and have wide ranging applications in different domains.

In some embodiments, the disclosed system and method may be used to determine value of other properties, such as, but not limited to, houses, and warehouse inventory.

### BRIEF DESCRIPTION OF THE DRAWINGS

FIG. 1 illustrates an operating environment comprising a system for determining a value of a damaged vehicle according to some embodiments;

FIG. 2 depicts a process for determining a value of a damaged vehicle according to some embodiments;

FIG. 3 depicts a neural network architecture according to some embodiments;

FIG. 4 depicts image analysis performed by a neural network according to some embodiments;

FIG. 5 illustrates an exemplary computing system that may be employed to implement algorithms for various embodiments.

### DETAILED DESCRIPTION OF THE INVENTION

All illustrations of the drawings are for the purpose of describing selected versions of the present invention and are not intended to limit the scope of the present invention.

Disclosed is a system and a method for determining a value of a damaged vehicle.

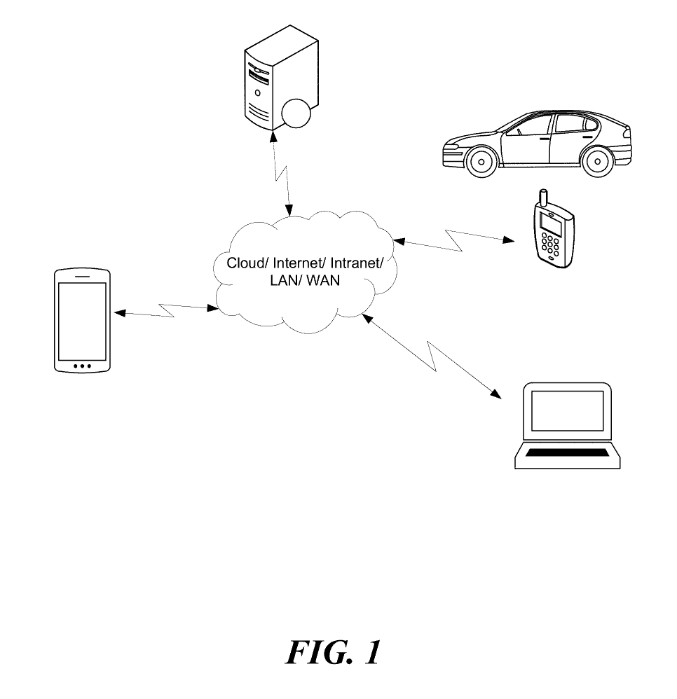

FIG. 1 illustrates an operating environment comprising a system for determining a value of a damaged vehicle. The vehicle may include, but is not limited to, a car, a truck, a boat, a bus, and heavy equipment.

A user may access the system using an electronic communication device, such as, but not limited to, a smartphone, a tablet, a laptop and a desktop. Further, the user may access the system via a wired or a wireless connection. Moreover, the user may access the system via one or more of a Cloud environment, the Internet, an Intranet, Local Area Network (LAN), Wide Area Network (WAN) and Metropolitan Area Network (MAN). The user may include one or more of a vehicle owner, a vehicle buyer, a broker, a vehicle mechanic and administrator. The user may access the system via one or both of an Internet browser and a software application such as a smartphone application.

The system may employ multiple algorithms to determining a value of a damaged vehicle. The system may maintain a database of past sales. The database may include information about one or more of vehicle type, vehicle year, vehicle make, vehicle model, vehicle series, mileage, engine type, original sale date, original sale price, repair estimate, air bags deployed, customer type, title type, and missing parts.

A user may provide information about a damaged car to the system. The system may analyze the information provided by a user to rate the damaged car against various parameters. Thereafter, the ratings against various parameters may be collated to obtain a value of the damaged vehicle.

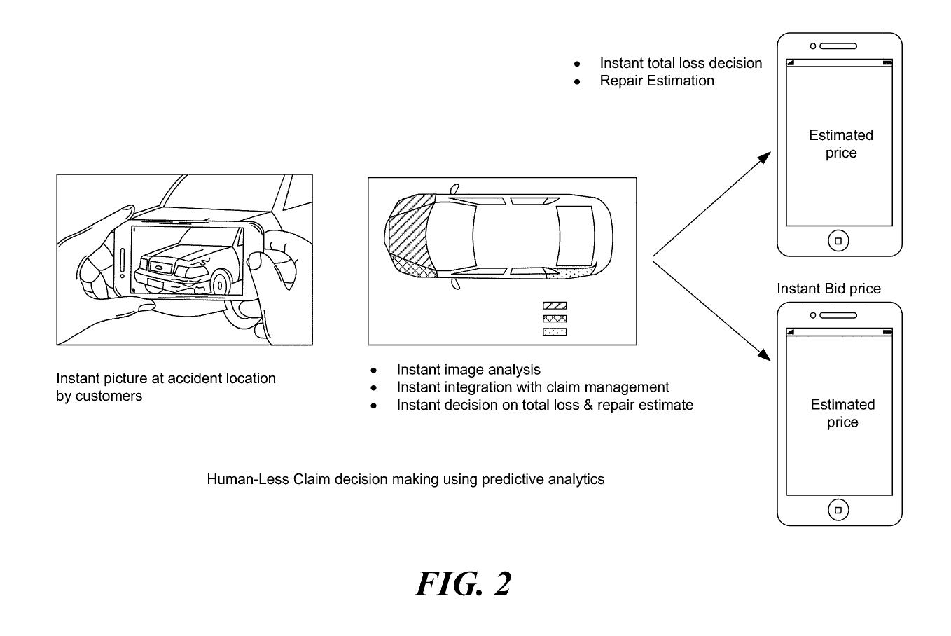

FIG. 2 depicts a process for determining a value of a damaged vehicle according to some embodiments. A user may use a smartphone to obtain photos of a damaged vehicle at the accident location. The photos may be sent to the system (of FIG. 1) for determining a value of a damaged vehicle. The system may perform instant image analysis of the photos to instantly calculate a total loss and repair estimate, which may be provided to the user on the smartphone. The system may also integrate with claim management application.

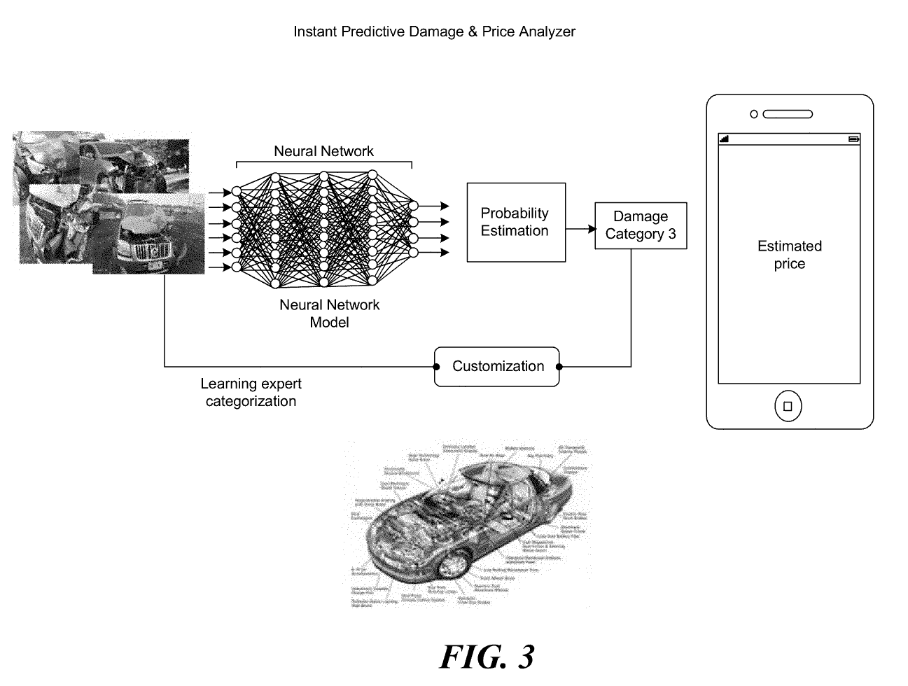

Further, the system may use a neural network to determine a value of a damaged vehicle. FIG. 3 depicts a neural network architecture for image analysis according to some embodiments. As shown, the neural network may include multiple inputs, one or more hidden layers. Further, experiments may be conducted to determine optimal network structure and optimal parameters for the neural network.

For the damaged vehicles uploaded from an inventory of salvaged vehicle sellers, pre-defined positions are identified, from which photos of the damaged vehicle have been taken. After pre-processing specific images, region detection and region cropping techniques may be used to train a custom Deep Learning Convolutional Neural Network (CNN) and associate it with the historical price of the vehicle. The goal here is to understand image based aspects of the damaged vehicle as perceived by an in-field expert. For example, the CNN may be trained to determine a level or category of damage based on image analysis. Based on the determined level or category of damage, the CNN may provide estimates for a total loss and repairs.

CNNs are responsible for major breakthroughs in image classification and are the core of most computer vision systems today. Accordingly, the system may use CNNs for image analysis of damaged vehicles and combine results with other vehicle related information to predict price accurately. As the name suggests, CNNs consist of different layers such as convolution layer, pooling layer and fully connected layer.

Apart from input layer and final output layer, the layers in between (hidden layers) can be customized to be combination of convolution and pooling layers. The number of layers can be adjusted to account for different aspects of the image. A combination of convolution and pooling layers may be stacked to focus on different aspects of the image.

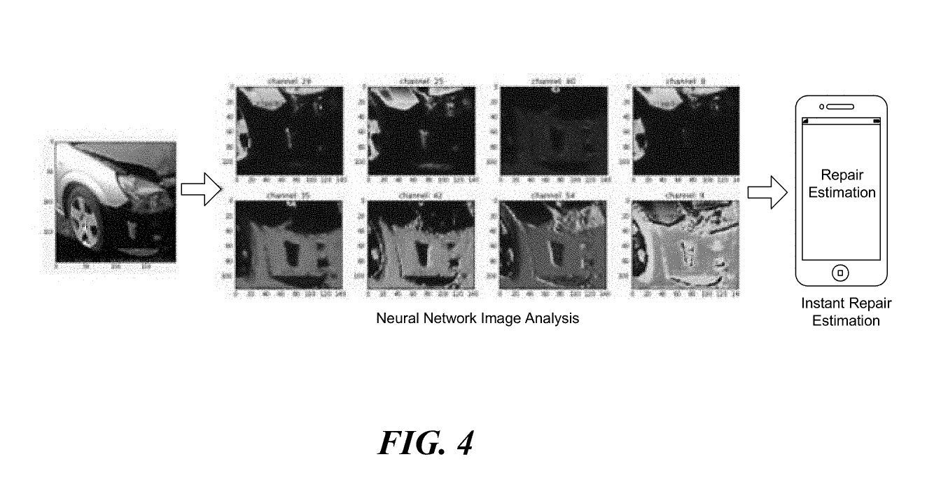

FIG. 4 depicts image analysis performed by a neural network according to some embodiments. Once the neural network is trained, it may be used to obtain estimates for a total loss and repairs. The neural network may analyze the photos of a damaged vehicle to determine damaged parts and severity of the damage. For example, the neural network may employ region-based comparison and shape-based comparison.

The neural network may determine the location of the damage; for example, vehicle's front, bottom, rear, driver's side, or passenger's side. The neural network may determine the damage to specific components; for example, front bumper, side mirrors headlight, windshield, tires, doors and windows. Further, the neural network may determine a level or a category of damage level; for example, slight, light, moderate, heavy, and totaled.

Finally, the neural network may provide estimates for a total loss and repairs.

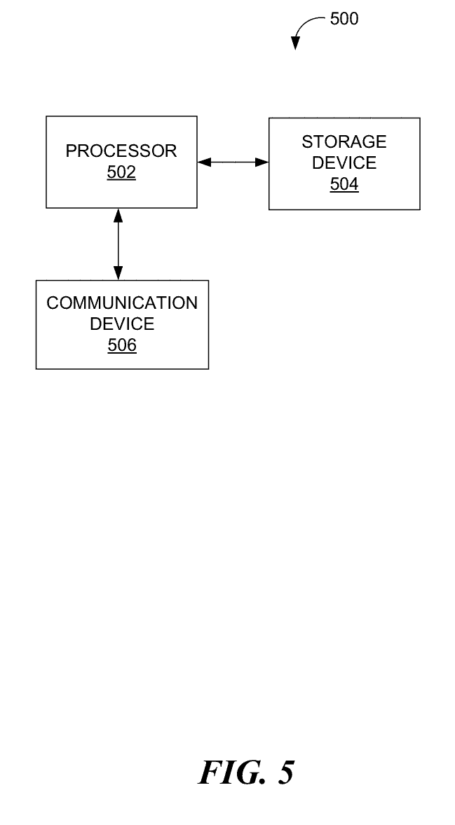

Referring now to FIG. 5, a block diagram of an exemplary computer system 500 for implementing embodiments consistent with the present disclosure is illustrated. Variations of computer system 500 may be used for implementing various systems, hardware, methods, and algorithms described above. The computer system 500 may relate to heterogeneous hardware such as desktop, laptops, mobile devices with various hardware configurations. Computer system 500 may comprise a processor 502. The processor may include a microprocessor, such as AMD Athlon, Duron or Opteron, ARM's application, embedded or secure processors, IBM PowerPC, Intel's Core, Itanium, Xeon, Celeron or other line of processors, etc. Processor 502 may be disposed in communication with a storage device 504 and a communication device 506. The communication device 506 may employ any communication protocols with wired or wireless networks. The storage device 504 may store a collection of program or database components. The databases may include SQL and NO-SQL databases such as MySQL, SQL Server, Oracle & Bid data databases. Further, different storage devices may be employed over cloud or on-premises and may be integrated with any extremal sources.

It will be appreciated that various above-disclosed embodiments, other features and functions, or alternatives thereof, may be desirably combined into many other different systems or applications. Various presently unforeseen or unanticipated alternatives, modifications, variations, or improvements therein may be subsequently made by those skilled in the art.

### Alternate Description

The present invention is a system and a method of externally assessing damage to a vehicle, typically after the vehicle is involved in an accident. The vehicle can be, but is not limited to, a car, a truck, a boat, a bus, or a piece of heavy equipment. The system for the present invention includes at least one remote server and a mobile computing device. The mobile computing device is preferably a smartphone with an integrated camera for taking digital pictures. After an accident, the mobile computing device allows a user to take digital pictures of the vehicle, which are sent to the remote server to be processed through a variety of references and damage analysis. The remote server preferably stores a damage inspection engine, a plurality of claims records, and a plurality of vehicle types (Step A). The damage inspection engine is an algorithm that is capable of processing visual data of a damaged vehicle into a quantified analysis of the severity of damage on different areas of the damaged vehicle. The plurality of claim records allows the present invention to reference past accidents in order to see how their claims were handled. The plurality of vehicle types allows the present invention to identify and reference what type was the damaged vehicle and what are some details of the damaged vehicle. Each vehicle type includes a plurality of part profiles and a current market value. Each part profile for a vehicle type is a depiction of the undamaged version of a part of the vehicle type so that each part profile can be used as a reference in the present invention. For example, the vehicle type can be a 1999 Ford Mustang, and the part profiles includes the 1999 Mustang-specific bumper and the 1999 Mustang-specific engine. The current market value is the amount the vehicle type is worth at the current date and is used by the present invention while making a claims decision.

The overall process for the method of the present invention allows a user to efficiently and effectively receive a quick claims decision after the user's vehicle is involved in an accident. The overall process begins by capturing visual data with a mobile computing device (Step B), wherein the visual data needs to depict the damaged areas of the vehicle. The visual data is preferably static digital pictures taken around from all angle of the vehicle. The overall process continues by relaying the visual data from the mobile computing device to the remote server (Step C) so that the remote server is able to process the visual data. The remote server then compares the visual data to each vehicle type in order to identify a matching type from the plurality of vehicle types. For example, if the remote server identifies the matching type to be a 1999 Ford Mustang, then the remote server will be able to use the proper referencing data for a 1999 Ford Mustang in subsequent steps of the overall process. The overall process continues by generating a damage-severity analysis for each part profile of the matching type with the remote server by inputting the visual data into the damage inspection engine (Step E). More specifically, the damage inspection engine processes the visual data, until the damage inspection engine is able to identify each part profile of the matching type within the visual data and is able to assess by how much each part profile was physically damaged in the accident. The overall process continues by assessing a repair cost for each part profile of the matching type with the remote server in accordance to the damage-severity analysis and the plurality of claims records (Step F). The repair cost for each part profile is based on what the repair cost was in previous claim records and then proportionately adjusted by how much each part profile was physically damaged in the accident. The remote server is then able to assess a claims decision in accordance to the repair cost for each part profile of the matching type and the current market value of the matching type (Step G). The claims decision is determined by the present invention in order to figure out if the vehicle is a total loss after an accident or if the vehicle is still repairable after the accident. The overall process concludes by relaying the claims decision from the remote server to the mobile computing device (Step H) and then outputting the claims decision through the mobile computing device (Step I) so that the user is notified of the claims decision.

The present invention identifies the matching type from the plurality of vehicle types by searching through the visual data for visual markers that are unique to a vehicle type. If the present invention is provided with a plurality of region-based visual markers for each vehicle type, then the remote server would compare the visual data to the region-based visual marker for each vehicle type in order to identify the matching type from the plurality of vehicle types. For example, the plurality of region-based visual markers would allow the present invention to differentiate between the European version of a 2007 Toyota Camry and the American version of a 2007 Toyota Camry. Similarly, if the present invention is provided with a plurality of shape-based visual markers, then the remote server would compare the visual data to the shaped-based visual marker for each vehicle type in order to identify the matching type from the plurality of vehicle types. For example, the plurality of shape-based visual markers would allow the present invention to differentiate between the standard model of a 2003 Nissan 350Z and the upgraded model of a 2003 Nissan 350Z based on the change of shape coming from not having a spoiler on the standard model and having a spoiler on the upgraded model.

The present invention uses the artificial intelligence integrated into the damage inspection engine to generate a damage-severity analysis for each part profile of the matching type. The damage inspection engine is preferably configured into a convolution neural network, which should be trained in order to execute the necessary steps of the present invention. The convolution neural network is provided with an input layer, a series of hidden layer, and an output layer. The input layer is used to process the visual data into the series of hidden layers with the remote server. The output layer is used to process the visual data out of the series of hidden layers. The series of hidden layers allows the damage inspection engine to convert the visual data into useful data to make a claims decision (i.e. damage-severity analysis for each part profile of the matching type). The series of hidden layers is any combination of convolution layers, pooling layers, and fully-connected layer that facilitate the efficient and effective generation of the damage-severity analysis. In addition, the convolution neural network also allows the present invention to detect a general region in the visual data associated to each part profile of the matching type as the visual data is processed through the convolution neural network with the remote server. The present invention is then able to crop the general region into an exact region in the visual data associated to each part profile of the matching type as the visual data is processed through the convolution neural network with the remote server. Consequently, the convolution neural network is able to accurately identify a distinct section of the visual data that is associated to each part profile.

The repair cost is also assessed with an artificially intelligent component of the present invention. The remote server initially averages the repair cost for each part profile of the matching type from the plurality of claims records during Step F, which allows the present invention to assess a baseline repair cost from previous management of similar claims. The remote server then proportionately adjusts the repair cost in accordance to the damage-severity analysis for each part profile of the matching type during Step F. Thus, if the damage-severity analysis for a part shows a large amount of physical damage, then the repair cost for the part is calculated to be larger. Otherwise, if the damage-severity analysis for the part shows a small amount of physical damage, then the repair cost for the part is calculated to be smaller. In addition, the repair cost is for the installation-labor cost and/or the replacement-part cost.

The claims decision is made by the remote server by comparing the financial cost of repairing the vehicle versus salvaging the vehicle. The remote server initially needs to calculate a total repair cost by summing the repair cost of each part profile. The total repair cost is how much would it cost to repair of the damaged parts on a vehicle in order to get the vehicle into a working condition. The remote server can then designate the claims decision as a total loss during Step G, if the total repair cost is greater than or equal to the current market value for the matching type. The present invention would then assess a total loss cost or also known a salvage price. Alternatively, the remote server can designate the claims decision as repairable during Step G, if the total repair cost is less than the current market value for the matching type. In the latter situation, the mobile computing device would also graphically output the damage-severity analysis and the repair cost for each part profile for the matching type during Step I so that the user is able to see the cost breakdown of repairing the damaged parts of the vehicle.

The present invention uses machine learning in order to improve its claims decisions as the present invention executes a plurality of iterations for Steps B through I. The remote server then assesses the plurality of iterations in order to identify procedural efficiencies in the Steps F and G, which are integrated into future iterations for Steps B through I with the remote server. Consequently, the procedural efficiencies in the Steps F and G acts as a kind of machine learning for the present invention so that better damage analysis is conducted by the present invention and more accurate repair costs are assessed by the present invention.

Although the invention has been explained in relation to its preferred embodiment, it is to be understood that many other possible modifications and variations can be made without departing from the spirit and scope of the invention as hereinafter claimed.

What is claimed is:

1. A method of externally assessing damage to a vehicle, the method comprises the steps of:
(A) providing a damage inspection engine, a plurality of claims records, and a plurality of vehicle types stored on at least one remote server, wherein each vehicle type includes a plurality of part profiles and a current market value;
(B) capturing visual data with a mobile computing device, wherein the visual data depicts a plurality of damaged areas for the vehicle;
(C) relaying the visual data from the mobile computing device to the remote server;
(D) comparing the visual data to each vehicle type with the remote server in order to identify a matching type from the plurality of vehicle types;
(E) generating a damage-severity analysis for each part profile of the matching type with the remote server by inputting the visual data into the damage inspection engine;
(F) assessing a repair cost for each part profile of the matching type with the remote server in accordance to the damage-severity analysis and the plurality of claims records;
(G) assessing a claims decision with the remote server in accordance to the repair cost for each part profile of the matching type and the current market value of the matching type;
(H) relaying the claims decision from the remote server to the mobile computing device; and
(I) outputting the claims decision through the mobile computing device.

2. The method of externally assessing damage to a vehicle, the method as claimed in claim 1 comprises the steps of:
providing a plurality of region-based visual markers for each vehicle type; and
comparing the visual data to the region-based visual markers for each vehicle type with the remote server during step (C) in order to identify the matching type from the plurality of vehicle types.

3. The method of externally assessing damage to a vehicle, the method as claimed in claim 1 comprises the steps of:
providing a plurality of shape-based visual markers for each vehicle type; and
comparing the visual data to the shaped-based visual markers for each vehicle type with the remote server during step (C) in order to identify the matching type from the plurality of vehicle types.

4. The method of externally assessing damage to a vehicle, the method as claimed in claim 1, wherein the damage inspection engine is configured into a convolution neural network.

5. The method of externally assessing damage to a vehicle, the method as claimed in claim 4 comprises the steps of:
providing the convolution neural network with an input layer, a series of hidden layers, and an output layer;
processing the visual data into the series of hidden layers through the input layer with the remote server; and
processing the damage-severity analysis for each part profile of the matching type out of the series of hidden layers through the output layer with the remote server.

6. The method of externally assessing damage to a vehicle, the method as claimed in claim 4, wherein the convolution neural network assesses the damage-severity for each part profile of the matching type as a specific level in an incremental series of damage levels.

7. The method of externally assessing damage to a vehicle, the method as claimed in claim 4 comprises the steps of:
detecting a general region in the visual data associated to each part profile of the matching type as the visual data is processed through the convolution neural network with the remote server; and
cropping the general region into an exact region in the visual data associated to each part profile of the matching type as the visual data is processed through the convolution neural network with the remote server.

8. The method of externally assessing damage to a vehicle, the method as claimed in claim 4, wherein a series of hidden layers is selected from a group consisting of: convolution layers, pooling layers, fully-connected layers, and combinations thereof.

9. The method of externally assessing damage to a vehicle, the method as claimed in claim 1 comprises the steps of:
averaging the repair cost for each part profile of the matching type from the plurality of claims records with the remote server during step (F); and
proportionately adjusting the repair cost in accordance to the damage-severity analysis for each part profile of the matching type with the remote server during step (F).

10. The method of externally assessing damage to a vehicle, the method as claimed in claim 1 comprises the steps of:
calculating a total repair cost with the remote server by summing the repair cost of each part profile;
designating the claims decision as a total loss with the remote server during step (G), if the total repair cost is greater than or equal to the current market value for the matching type; and
designating the claims decision as repairable with the remote server during step (G), if the total repair cost is less than the current market value for the matching type.

11. The method of externally assessing damage to a vehicle, the method as claimed in claim 10 comprises the steps of:
wherein the total repair cost is less than the current market value for the matching type; and
graphically outputting the damage-severity analysis and the repair cost for each part profile for the matching type through the mobile computing device during step (I).

12. The method of externally assessing damage to a vehicle, the method as claimed in claim 1 comprises the steps of:
executing a plurality of iterations for steps (B) through (I);
assessing the plurality of iterations with the remote server in order to identify procedural efficiencies in steps (F) and (G); and
integrating the procedural efficiencies in steps (F) and (G) into future iterations for steps (B) through (I) with the remote server.
